(19) United States
(12) Patent Application Publication
(10) Pub. No.: US 2007/0287440 A1
(43) Pub. Date: Dec. 13, 2007

(54) System and method for maintaining system information in a mobile telecommunications system

(75) Inventors: Michael Benkert, Hohenassel (DE); Michael Eckert, Braunschweig (DE); Bernd Kemmer, Eichenau (DE); Hyung-Nam Choi, Hamburg (DE)

Correspondence Address: DICKSTEIN SHAPIRO LLP, 1177 AVENUE OF THE AMERICAS (6TH AVENUE), NEW YORK, NY, 10036-2714, US

(73) Assignee: Infineon Technologies AG, Munich (DE)

(21) Appl. No.: 11/422,794

(22) Filed: Jun. 7, 2006

(51) Int. Cl. H04Q 7/20

(52) U.S. Cl. 455/422.1

(57) ABSTRACT

System information data transfer within a mobile telecommunication system to ensure that a piece of user equipment always has the most up to date information. Data is sent to the user equipment and includes information indicating a time of change of the active system information. The user equipment can use the time of change information to verify whether the system information it has stored is the latest version of the system information.

### BACKGROUND OF THE INVENTION

The present invention generally relates to the field of mobile telecommunication systems and, in particular, to the operation of the user equipment (UE), as well as of the base stations, in such system. The invention may applied in the Universal Mobile Telecommunications System (UMTS) framework as well as 3GPP systems and future generations of mobile telecommunications standards.

The use of mobile phones in today's society is extremely commonplace with the vast majority of people owning a mobile phone. In light of the increase in the number of mobile phones, the demands on the requirements of networks is ever increasing. The latest mobile phone networks operate to provide a great range of multimedia services along with standard telecommunication services. Such systems are often designed to deliver high capacity mobile communication with high data transfer for multimedia services. Within such a system, there exists a great many possibilities for configuring terminals and networks.

Pieces of user equipment, UE, operating within the networks, are constantly supplied with active system information. Such system information, is typically related to repetition rates, radio communication channels and the like. It is vital that each UE within the network is provided with the most recent system information. With such system information, the UE is able to communicate effectively and instantaneously with the radio network, and is further able to maintain radio communication therein. The system information is continuously broadcast over the entire network. The user equipment maintains a link with this broadcast and is able to obtain the relevant system information.

Within a mobile telecommunications system (MTS) a plurality of pieces of user equipment UE, will be controlled with a radio net controller Base Station, BS. Within the MIS, it is necessary for the radio net controller to control the radio communication with each piece of user equipment. System relevant information is sent from the BS to each of the radio cells in the MIS. As described above, such system information is related to channel maintenance, repetition rate etc. of the radio communication. In order for the system to function appropriately, it is necessary for each of the UEs within the MIS to possess the latest system information.

The system information is typically broadcast in system information packets. Other information packets are also broadcast over the network, and these information packets contain reference information relating to the system information packets. Receipt of the reference information at the UE informs the UE of the necessary details regarding the transmitted system information. In order that the UB is aware of an update of the system information, the reference information is typically provided with a value tag. This value tag remains the same for the reference information whilst ever it remains active. However, once the system information is updated, the value tag associated with the reference information is changed. When the UE receives the broadcast system information, the UE checks the value tag associated with the reference information. When the value tag remains unchanged, the UE knows that the system information has not been amended, and does not need to read and store the recdived system information data. When new system information is sent across the network, however, the value tag associated with the reference information is updated. At this point the UE recognises that the value tag has changed, and therefore knows that the system information has also changed. The UE will read and store the new system information, and thereby maintain appropriate connection within the network.

Whenever ever the UE is in contact with the radio communication system, it is able to receive the broadcast information. As such, the UE will notice the change in the value tag associated with the reference information, and will therefore immediately notice the change in the system information. On other occasions, however, the UE is not receiving, or is in a state where it is not monitoring the reference information being broadcast. When such a UE begins monitoring the reference information again, it needs to determine if the system information has changed from that currently stored in the UE. It is conceivable that a UE is not monitoring or receiving reference information for a reasonable length of time, such that the system information has changed several times since contact with the broadcast information stopped. It is further conceivable, that the value tag associated with the reference information can repeat itself in non-temporally adjacent broadcasts. That is, when new system information is being provided, the value tag associated with the old reference information must be different from the new. Unfortunately, nothing prevents the value tag associated with subsequent transmissions from being the same as the first value tag. In such a case, all that is noted by the UE is that the value tag has changed and the UE therefore assumes that the system information must have been updated. In light of the above, therefore, it is possible that a UE that has not been receiving or monitoring the broadcasts, could begin receiving the reference information at a point where the value tag associated with the current reference information is the same as that of the reference information when the UE stopped receiving or stopped monitoring.

If a UE upon re-monitoring or receiving the reference information discovers that the value tag has not changed, it will not read and store any system information. This is a result of the UE determining that the system information has not changed. If, however, the above scenario had occurred, then the UE would not be able to properly integrate with the radio communication network, and setting up a radio communication channel would not be instantly possible. If this were to occur, the UE would then require time and overhead to interact with the communication network, obtain relevant information and search for a ready communication channel. Each of these uses both power and time, inconveniencing the user and further the network system in general.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1a is a flow chart indicating the steps performed in a piece of UE according to the invention;

FIG. 1b is a flow chart indicating further steps which can be performed by a piece of UE according to the invention; and

FIG. 2 is a table showing the a master information block (MIB), according to the present invention, whom applied to the UMTS.

### DESCRIPTION OF THE INVENTION

The present invention overcomes the above-mentioned problems, by the equipment and methods described and claimed herein.

In accordance with the present invention the MTS is configured to include information indicating the time of change of the active system information. This information is incorporated within data that is received by a piece of user equipment within the MTS.

In light of this feature of the present invention, it is possible for the piece of UE to instantly recognize the time of change of the active system information, and therefore whether it is necessary to read and store the system information being transmitted. For example, if the UE knows that it has not monitored the network for three hours, and the information indicates that the system information was changed an hour ago, the UB recognizes that it must read and store the updated system information.

In order to enable user equipment that has not received or monitored the reference information for some time, to be able to accurately determine if the received reference and system information is in fact newer than the stored information, the present method and equipment incorporates the time of change of the reference and system information with the data.

The current invention relates to equipment and methods of operating the equipment, in which the reference information includes information indicating the time of change of the system information. In such a manner, the UE when receiving the reference information is able to judge whether the value tags differ from one piece of reference information to the next, and should these values be the same, the time of change of the system information is then compared.

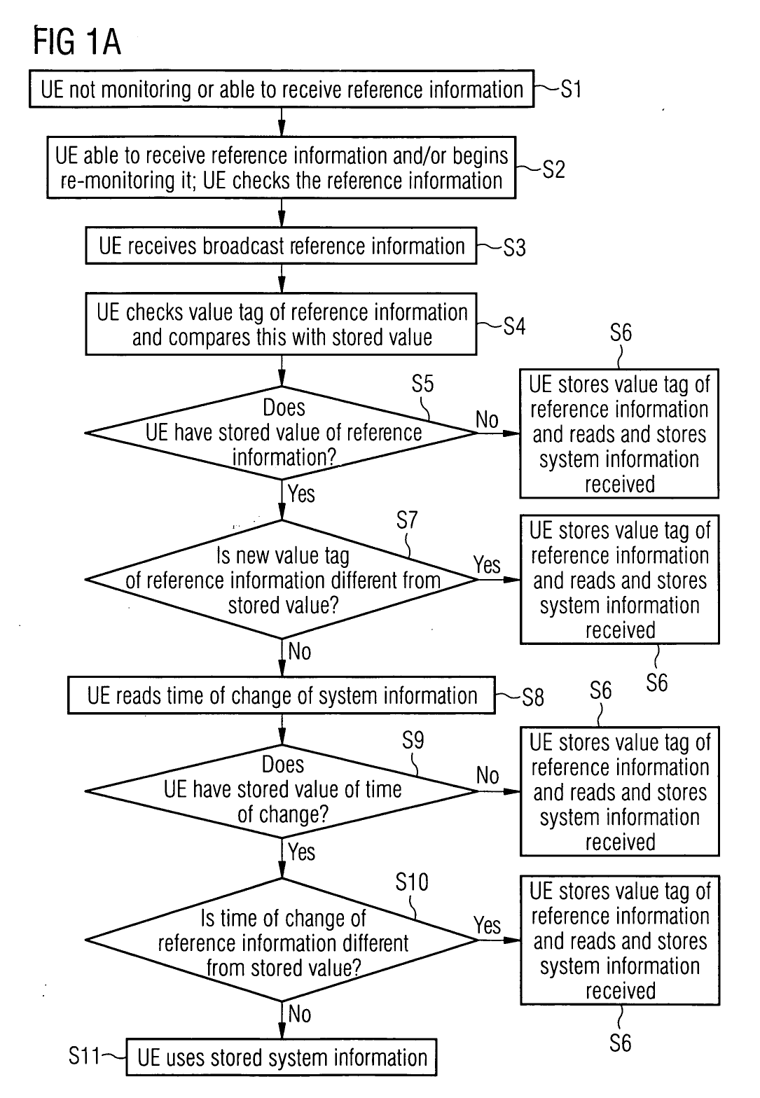

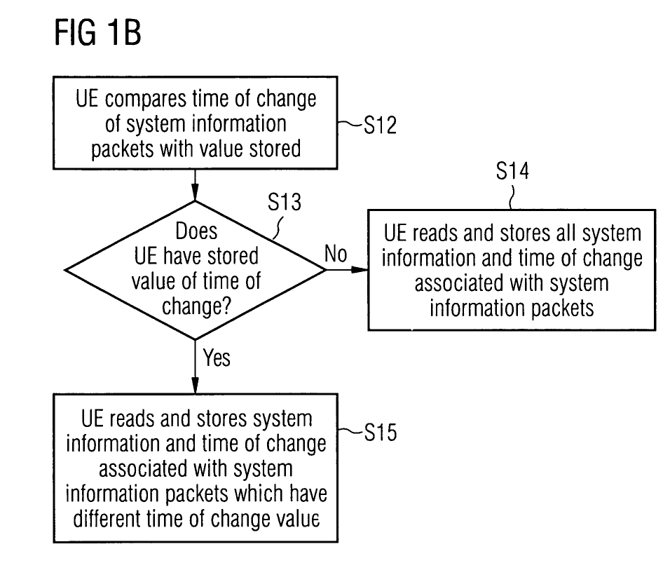

A detailed description of operating the method is given below, and with reference to the flow chart of FIG. 1a.

A piece of user equipment is operating within a MTS, and is in radio communication with the base station in the system. In such a manner, the user equipment is constantly receiving the reference information broadcasts, and is able to maintain the active system configuration data. When the UE stops monitoring or is unable to receive the reference information, none of the reference information data is read (step S1). Upon re-monitoring or being able to receive the reference information again, the UE once again checks the reference information (step 52). The new reference information that is received, has an associated value tag indicating which version of the reference information has been received. In addition to this value tag, the invention provides that the reference information data also includes an information element indicating the time at which the current active system information was changed.

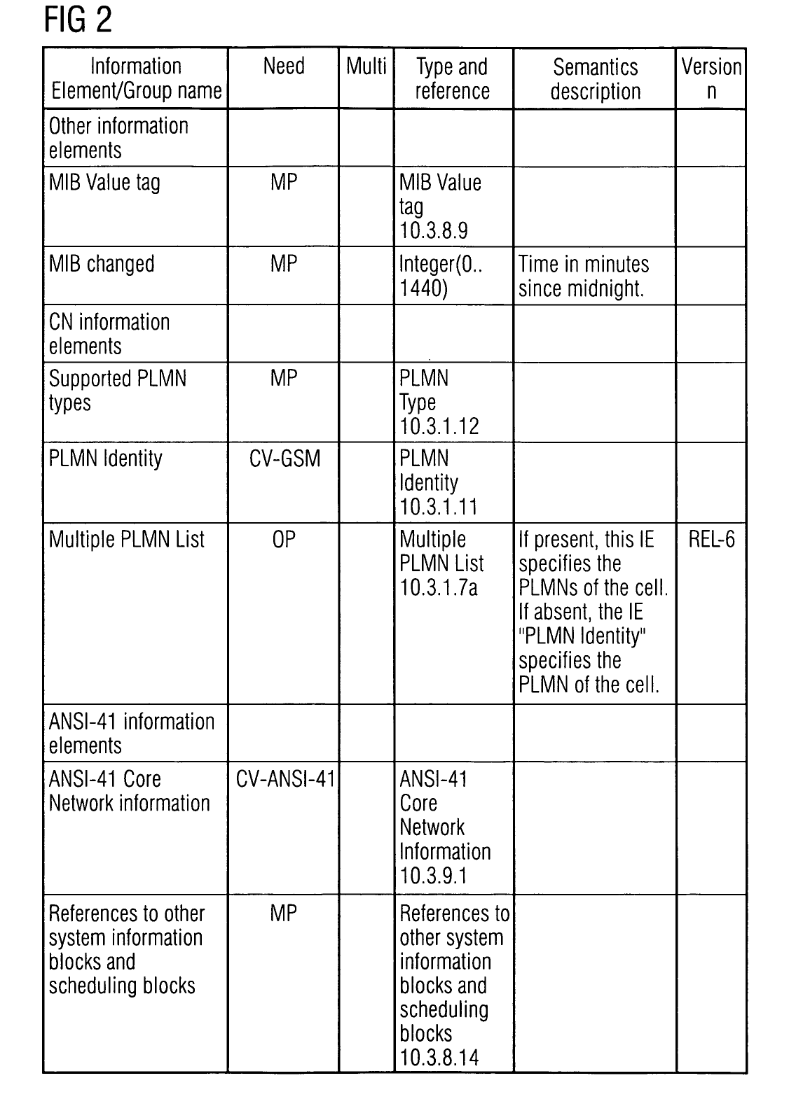

FIG. 2 is a table showing an example of possible elements in the reference information, according to the present invention. This reference information includes the value tag indicating the version of the system and reference information. Further, the reference information can include core network (CN) information relating to the mobile network (PLMN in the figure) types, identity, and optionally, the listing within each cell. Additionally, American National Standards Information (ANSI) can be included within the reference information. Finally, as shown in FIG. 2, an information element indicating the time of change of the system information is included. Within the table, this information is given the name “MIB changed”, although this is simply by way of example and is not intended as a limitation.

Returning to FIG. la, upon receipt of the reference information (step S3), the UE checks the value tag of the reference information. This value tag is then compared with the stored value within the UE that relates to the last received reference information. If the piece of UE does not contain data relating to previously stored reference information (step S5), that is there is no stored value tag associated with previous reference information, the UE stores the details of the value tag. Additionally, as the UE does not contain the relevant system information, it reads and stores the system information that it has just received, along with the value of the value tag, (step S6). If, however, the UE does contain previously stored reference information system data, the newly received value tag associated with the new reference information is compared with that previously stored (step S7). If the value of the received value tag differs from that of the stored value tag, the UE determines that the received reference information relates to new system information, and therefore reads and stores the system information which is related to the reference information and stores the new value tag (step S6). In this manner, if new system information has been broadcast during the time that the UE was not monitoring or receiving the reference information, the UE is able to get knowledge about the existence of new system information.

In certain circumstances, the UE upon re-monitoring or newly receiving the reference information, will read the associated value tag and find this to be the same as the stored value. In this situation, the piece of UE then compares the information element related to the time of change of the system information received with the reference information (step S8), in order to determine the time of change of the active system information. That is, the UE does not simply accept that because the value tag of the received reference information matches that of the previously stored received reference information value tag, that the system information has not been updated. In this manner, should the reference information value tag change numerous times and repeat itself, the UE is still able to determine whether the stored system information is the same as the received active system information.

More concretely, the UE upon receipt of the reference information and determination that the value tag associated with this received reference information is the same as the stored value, checks the information element related to the time of change of the system information received with the reference information. The UE compares the received value with the value stored within itself (step S9). If the UE does not contain a value associated with the information element related to the time of change, the UE will then assume that it does not have the active system information, and will update the system information related to the received reference information (step S6). Additionally, if the UE does contain information related to the time of change, but this is different from the received value, (step S10) the UE also recognizes that the currently stored system information is not the same as the active system information, and also reads and stores the system information indicated by the current reference information (step S6). If, however, the received time of change value matches the value stored within the UE, the UE recognizes that it currently has the most up to date system information. As such, it simply uses tat which is stored (step S11).

By following the above method, the piece of user equipment is able to determine whether the system information indicated in the reference information is indeed different from that currently stored in the user equipment- Furthermore, the use of the information element related to time of change, denoted as a “time of change information (element)”, removes the possibility of the user equipment mistakenly believing tat te stored system information is the same as the active system information, if the determination is based upon the use of the reference information value tag. The use of the time of change information element is particularly useful, as this can readily be incorporated within current MTS without disruption of te service, and without complete overhaul of the system. That is, current user equipment tat is not adapted for reading the time of change information element, will still function using the received information value tags, whereas user equipment tat is adapted to read the additional information element will operate more efficiently. Clearly, this accurate determination of the active system information assures that each piece of UE has the correct system information configured within itself. Maintaining the accurate system information, has the key advantages of ensuring that the system does not waste time with unnecessary processing, in that the UE does attempt to use an inappropriate radio communication channel. Additionally, the present invention avoids problems with the UE searching for inappropriately configured radio channels, and therefore reduces the power consumption of the system as a whole.

An additional embodiment that can be optionally included in the above method, relates to the system information, and is shown in FIG. 1b. Typically, the system information is split into a plurality of packets and received at the UE. The reference information is related to these system information packets, and it is these which transfer the actual system information to the UE. In the additional embodiment of the present invention each packet is also provided with a time of change information element, which again is the lime of change of the individual packets. In this embodiment the UE determines which of the individual packets have been changed. That is, rather than downloading the entire system information related to the reference information, the UE checks the time of change of each system information packet with that currently stored, and determines which had been amended and which could be maintained. Clearly this time check does not cost much in overhead, and also ensures that the UE only updates the relevant system information data which had changed.

In the same manner as the above, each system information packet received, contains time of change data. The UE, upon determination that the system information had changed, according to the steps in figure la, instead of following 86 from FIG. 1a, the method proceeds to step S12. In step S12, the UE compares the time of change of the system information with the stored value and determines whether each system information packet had in fact been changed. If no data relating to the time of change of the system information packet is stored within the UE, (step S13) the UE reads and stores all of the system information received as well as the time of change of each packet (step S14). Any packets with time of change values different from those of the value stored in the UE, are also be assumed by the UE as having changed, and are therefore read, stored and the time of change value updated (step S15). Of course, any system information packets with time of change values equal to the stored values, are judged as not having changed, and therefore no reading and storing is required. In this manner, only those elements that had changed are required to be read and stored by the system (step S15).

While the above discussion has centred on the reception of the system information and time of change of such at the UE, the BS within such a MTS will now be discussed. The BS continually broadcasts to all of the UEs the system information and the associated reference information. During its normal operation, the BS is continually updating the system information, including the communication channels, repetition rates and the like. This is transmitted over a known channel to the area covered by the BS, indicating the relevant data. In order that users within the BS environment are able to monitor these changes, the reference information data is provided with a value tag, as an indication of the generation of the data. Whenever the broadcast information changes, the BS will change the value tag associated with the reference information and transmit this changed value tag with the new reference information. Each time the system information changes, the value tag transmitted with the reference information changes.

Over several changes of the system information, it is possible for the value tag associated with non-temporally adjacent transmissions to repeat. As such, the ES can further incorporate the time of change of the system information into the reference information being transmitted. Each time the system information changes, the BS changes the value tag and transmits this along with the time of change of the information.

Additionally, as has been discussed above, the system information is often in packet form. That is, the system information is transmitted by the BS in the form of a plurality of packets. It is further possible, in addition to the above time of change being transmitted with the reference information, to associate the time of change of the individual packets of system information. In this way, when an individual packet has been changed, the reference information incorporates the time of change indication, and additionally the packet of system information also includes the time of change. Therefore, the BS monitors the time of change of each individual system information packet, and transmits the relevant time of change of each of these along with the system information packet.

A further embodiment of the MIS and method of operating, relates to sending a time of change element of system information to the UE upon state transition into a state from un-monitoring the broadcasts to monitoring. When a piece of UE state transits, this is associated with signalling messages received at the UE.

In this embodiment the MIS is configured such that the signalling messages received at the UE contains the time of change information element, and the UE is instantly made aware of the time of change of the current system information. The UE then compares the time of change information element received, with that of the value stored. If the time of change of system information received with the signalling messages does not match that of the stored value within the UE, the UE is aware that the system information it currently has is out of date. In this situation, the UE reads the reference information, and reads and stores the system information associated therewith. In this manner, the UE is immediately provided with the relevant system information, and as such can instantly initiate the communication. By undertaking this method, the UB does not waste system resources in attempting to radio communicate along an invalid channel, wastes less power by not attempting to begin radio communication across such an invalid channel, and further is immediately able to communicate within the MIS.

A BS operating within the above disclosed MTS, monitors the UE and notes when this UE transits between states where it is or is not able to monitor or receive the system information. Such changes require that the BS transmit signalling messages which initiate contact and the like. The base station in the current embodiment, in addition to transmitting these signalling messages, is also adapted to transmit the time of change of the system information. Transmitting this time of change information, along with the signalling messages, immediately indicates to the UB the age of the reference information and associated system information.

In each of the above described embodiments, the lime of change information element is sent to the UE using standard communications. That is, the reference information contains the lime of change information element, the standard signalling messages received by the UE on state transition, contain the lime of change information element. It is possible for this information element to be sent in a number of ways. For example, the lime could be based upon the RFC868 time protocoL which is a 32 bit word which indicates the time in seconds since midnight of Jan. 1, 1900. While this is clearly a very accurate way of the UE monitoring the time of change of the system information, it also requires the overhead of sending a 32 bit word over the UMTS. It is preferably possible, therefore, for the additional information element to be a 12 bit word, that indicates the changed lime in minutes since midnight of the current day. Of these two, it is accepted that the second option, that of sending a 12 bit word, requires less system overhead and furthermore provides sufficient accuracy for the UE.

The above description and embodiments are presented by way of example only, and the elements from each embodiment could readily be combined. For example, the embodiment relating to the lime of change being received with signalling messages could also be combined with the individual system information packets containing the lime of change. That is, upon state transition, the UE could be informed of an update of the system information, and then could check which of the packets it is necessary to change.

Additionally, as has been discussed above, the system of the present invention can readily be adopted into existing systems. By way of example, and without any limitation, the above equipment and methods could be combined with the Universal Mobile Telecommunications System, UMTS. For example, within this system, the control and system information is continually broadcast over a broadcast channel, BCH. The UTE is intended to maintain contact with this channel, and thereby obtain the relevant control and system information. The system information packets, are transferred over the BCH as System Information Blocks, SIB. The organisation of these blocks being signalled by the reference information, which is in the form of Master Information Blocks, MIB. These blocks perform the same duties as has been discussed above, and can be considered as analogous. Additionally, the UE within the UMTS maintains a link with the BCH, unless it enters a CELL_DCH state, in which case the UE does not monitor the MIB being transmitted. Upon leaving the CELL_DCH state, the UE receives the BCH and then monitors the MIB value tag to determine the status of the system information, and whether it currently has the most up to date.

As has been described above, the example system according to the UMTS, can suffer from the repetition of the value tag associated with the MIB. In accordance with the present invention, the MIB received at the UE is adapted to include a time of change element which indicates the time of change of the system information. The UE then monitors the MIB, and in the manner described above with relation to FIG. 1a, determines if the system information requires updating. Furthermore, it is possible for each SIB to be provided with time of change data, which can be read by the UE and used to determine which of the blocks require reading and storing.

Numerous states exist within the UMTS for the UE to transit into. In particular, when the UE is in the CELL_IJCH state, and not receiving the BCH, upon transition to other states in which it does monitor the BCH, such as the CELL_FACH or CELL_PCH or URA_PCA state, the UE can immediately determine if it has the correct system information. Additionally, the time of change associated with the system information can be received at the UE along with state transition signalling messages.

The BS within the UMIS, provides the MIB and SIB broadcast over the BCH. This BS can readily be adapted to incorporate the information within the MIS, relating to the change of time of the system information. Additionally, it would be further possible to include the time of change of each of the SIBs transmitted over the BCH.

1-44. (canceled)

45. A method for ensuring that a user equipment in a mobile telecommunications system possesses a set of correct system information relating to the mobile telecommunications system, the method comprising:
receiving information relating to a time of change of system information, in data received by the user equipment; and
using the received information at the user equipment to determine if a stored set of system information is a set of correct system information.

46. The method according to claim 45, wherein the time of change information is included in reference information, relating to system information received at the user equipment, and wherein the time of change information is in addition to a value tag of the reference information, the value tag relating to a characteristic of the system information.

47. The method according to claim 46, further comprising:
the user equipment initially checking the reference information value tag;
comparing the reference information value tag with a stored value; and
if the reference information value tag is different from the stored value, or if there is no stored value, the user equipment:
storing the reference information value tag; and
reading and storing the system information associated with the reference information.

48. The method according to claim 47, further comprising:
if the reference information value tag is the same as the stored value, the user equipment comparing the time of change information with a stored value, and if the time of change information is different from the stored value, or if there is no stored value, the user equipment:
storing the time of change information;
storing the reference information value tag; and
reading and storing the system information associated with the reference information.

49. The method according to claim 48, further comprising:
if the reference information time of change value is the same as the stored value, the user equipment using the stored system information.

50. The method according to claim 49, wherein packets of system information, indicated by the reference information, received at the user equipment, also contain information indicating the time of last change, the method further comprising:
the user equipment comparing this information for each packet of system information with a stored value associated with each packet of the currently used system information; and
the user equipment updating only those stored values with a different value.

51. The method according to claim 45, further comprising:
the user equipment receiving the time of change information with a signalling message when the user equipment transits from a state of not monitoring the reference information to a state which is monitoring the reference information, or when the user equipment begins to receive the reference information after a period of not receiving the reference information; and
the user equipment:
comparing the time of change in the received time of change information with a stored time of change value;
downloading the new system information if the value is different; and
using the current stored system information if this value is the same.

52. The method according to claim 51, wherein packets of system information received by the user equipment, associated with reference information received by the user equipment, also contain information indicating the time of last change, the method further comprising:
the user equipment comparing this information element for each packet of system information with the value stored with each packet of the currently used system information, and updating only those stored values with a different value.

53. The method according to claim 45, wherein the time of change information is a 12-bit word indicating the time of day in minutes since midnight.

54. The method according to claim 45, wherein the time of change information conforms to the RFC 868 time protocol, which is a 32-bit word indicating the time in seconds since midnight Jan. 1, 1900.

55. A method for ensuring that a set of system information, related to a mobile telecommunications system, stored in a user equipment, is the most current information, the method comprising:
during a state transition in the user equipment from a state of not monitoring reference information associated with the system information to a state that is monitoring the reference information, or when the user equipment begins to receive the reference information after a period of not receiving the reference information, the user equipment receiving information indicating a time of change of the system information associated in reference information and/or each packet of system information;
the user equipment comparing this received time of change with a stored time of charge value; and
the user equipment downloading the received system information if the stored time of change value is different, and using the current stored system information if the stored time of change value is the same.

56. A method for updating a set of system information related to a mobile telecommunications system in a piece of user equipment, the method comprising:
including time of change information in reference information associated with the system information, wherein the time of change information indicates a time of change of the system information, and is in addition to a reference information value tag associated with the reference information;
receiving the reference information by the user equipment;
comparing, in the user equipment, the received reference information value tag with a stored reference information value;
if the reference information value tag is different from the stored reference information value, or if there is no stored reference information value, the user equipment:
storing the reference information yalue tag; and
reading and storing the system information associated with the reference information; and
if the reference information value tag is the same as the stored reference information value, the user equipment:
comparing the time of change information in the reference information, with a stored time of change value;
if the time of change information is different from the stored time of change value, or if there is no stored time of change value, the user equipment storing the time of change information, storing the reference information value tag and reading and storing the system information associated with the reference information; and
if the time of change value is the same as the stored time of change value, the user equipment uses the stored system information.

57. The method according to claim 56, wherein packets of system information indicated by the reference information also contain time of change information, the method further comprising:
the user equipment comparing the time of change information for each packet of system information with the stored time of change values, and updating only those packets of system information with a different value.

58. A user equipment for use in a mobile telecommunications system, the user equipment comprising:
an interface that receives and reads information relating to a time of change of system information of the mobile telecommunications system,
wherein the user equipment uses the information to determine if a stored set of system information is a set of correct system information.

59. The user equipment according to claim 58, wherein the time of change information is included in reference information, relating to system information, received at the interface, and is in addition to a reference information value tag, the reference information value tag relating to a characteristic of the system information.

60. The user equipment according to claim 59, wherein the user equipment initially checks the received reference information value tag, and compares the received reference information value tag with a stored reference information value, and if the received reference information value tag is different from the stored reference information value, or if there is no stored reference information value, stores the reference information value tag and reads and stores the system information associated with the reference information.

61. The user equipment according to claim 60, wherein if the reference information value tag is the same as the stored reference information value the user equipment compares the received time of change information with a stored time of change value, and if the received time of change information is different from the stored time of change value, or if there is no stored time of change value, the user equipment stores the time of change information and stores the reference information value tag, and reads and stores the system information associated with the reference information.

62. The user equipment according to claim 61, wherein if the reference information time of change value is the same as the stored time of change value, the user equipment uses the stored system information.

63. The user equipment according to claim 62, wherein packets of system information, received at the interface also contain time of change information indicating the time of last change, the user equipment further compares the time of change information for each packet of system information with a stored time of change value associated with each packet of the currently used system information, and updates only those with a different value.

64. The user equipment according to claim 58, wherein the interface receives the time of change information with a signalling message when the user equipment transits from a state of not monitoring the reference information to a state which is monitoring the reference information, or when the user equipment begins to receive the reference information after a period of not receiving the reference information; and
wherein the user equipment compares he time of change in the received time of change information with a stored time of change value and downloads the new system information if the stored time of change value is different, or uses the current stored system information if the stored time of change value is the same as the received time of change information.

65. The user equipment according to claim 64, wherein packets of system information received by the user equipment also each contain time of change information indicating the time of last change, the user equipment compares the received time of change information element for each packet of system information with the stored time of change value with each packet of the currently used system information, and updates only those packets of system information with a different value.

66. The user equipment according to claim 58, wherein the time of change information is a 12-bit word indicating the time of day in minutes since midnight.

67. The user equipment according to claim 58, wherein the time of change information conforms to the RFC 868 time protocol, which is a 32-bit word indicating the time in seconds since midnight Jan. 1, 1900.

68. A user equipment in a mobile telecommunications system, wherein during a state transition in the user equipment from a state of not monitoring reference information associated with system information of the mobile telecommunications system to a state that is monitoring the reference information, or when the user equipment begins to receive the reference information after a period of not receiving the reference information, the user equipment receives information indicating a time of change of the system information contained in reference information or contained in each packet of system information, and wherein the user equipment compares the received time of change with a stored time of change value and downloads the received system information if the value is different, or uses the current stored system information if the value is the same.

69. A user equipment in a mobile telecommunications system,
wherein the user equipment receives reference information associated with the system information, the reference information includes time of change information that indicates a time of change of the system information, and is in addition to a reference information value tag associated with the reference information;
wherein the user equipment checks the received reference information value tag and compares the received reference information value tag with a stored reference information value, if the received reference information value tag is different from the stored reference information value, or if there is no stored reference information value, the user equipment stores the reference information value tag and reads and stores the system information associated with the reference information;
if the reference information value tag is the same as the stored reference information value, the user equipment compares the time of change information in the reference information with a stored time of change value, and if the received time of change information is different from the stored time of change value, or if there is no stored time of change value, the user equipment stores the time of change information, stores the reference information value tag and reads and stores the system information associated with the reference information; and
if the received time of change information is the same as the stored time of change value, the user equipment uses the stored system information.

70. The user equipment according to claim 69, wherein packets of system information associated with the reference information received at the user equipment, also contain time of change information indicating the time of last change, and the user equipment compares the time of change information for each packet of system information with the time of change value stored with the currently used packets of system information, and updates only those with a different value.

71. A method for ensuring that a user equipment in a mobile telecommunications system possesses a set of correct system information relating to the mobile telecommunications system, the method comprising:
at a base station, including time of change information that relates to a time of change of system information, in data to be transmitted over the telecommunications system.

72. The method according to claim 71, wherein the time of change information is included in reference information, relating to the system information transmitted by the base station, and is in addition to a reference information value tag.

73. The method according to claim 71, wherein packets of system information transmitted by the base station also contain time of change information indicating the time of last change.

74. The method according to claim 71, wherein the time of change information is transmitted by the base station with a signalling message when the user equipment transits from a state of not monitoring the reference information to a state that is monitoring the reference information, or when the user equipment begins to receive the reference information after a period of not receiving it.

75. The method according to claim 71, wherein the time of change information is a 12-bit word indicating the time of day in minutes since midnight.

76. The method according to claim 71, wherein the time of change information conforms to the RFC 868 time protocol, which is a 32-bit word indicating the time in seconds since midnight Jan. 1, 1900.

77. A base station, which is in a mobile telecommunications system, includes time of change information in data to be transmitted over the telecommunications system, the time of change information relating to a time of change of system information related to the mobile telecommunications system.

78. The base station according to claim 77, wherein the time of change information is included in reference information, relating to the system information, transmitted by the base station, and is in addition to a reference information value tag.

79. The base station according to claim 77, wherein packets of system information, indicated by the reference information, transmitted by the base station, also contain time of change information indicating the time of last change.

80. The base station according to claim 77, wherein the base station transmits the time of change information with a signalling message when the user equipment transits from a state of not monitoring the reference information to a state that is monitoring the reference information, or when the user equipment begins to receive the reference information after a period of not receiving it.

81. The base station according to claim 80, wherein the base station includes time of change information, which indicates the time of last change within packets of system information transmitted by the base station, and that are associated with reference information transmitted by the base station.

82. The base station according to claim 77, wherein the time of change information is a 12-bit word indicating the time of day in minutes since midnight.

83. The base station according to claim 77, wherein the time of change information conforms to the RFC 868 time protocol, which is a 32-bit word indicating the time in seconds since midnight Jan. 1, 1900.

84. A mobile telecommunications system that ensures that a user equipment connected to the mobile telecommunications system possesses a set of correct system information relating to the mobile telecommunications system, the mobile telecommunications system comprising:
a base station that transmits data including time of change information relating to a time of change of system information to the user equipment,
wherein the user equipment uses the received time of change information to determine if a stored set of system information is a set of correct system information.

85. The mobile telecommunication system according to claim 84, wherein the time of change information is included in reference information, relating to system information, received at the user equipment, and is in addition to a reference information value tag, the reference information value tag relating to a characteristic of the system information.

86. The mobile telecommunication system according to claim 84, wherein the time of change information is a 12-bit word indicating the time of day in minutes since midnight.

87. The mobile telecommunication system according to claim 84, wherein the time of change information conforms to the RFC 868 time protocol, which is a 32-bit word indicating the time in seconds since midnight Jan. 1, 1900.

88. A mobile telecommunications signal manifested in physical form in a mobile telecommunications system, the signal comprising:
a data block containing reference information containing active system information concerning user equipment, the reference information including a current tag, the current tag information being updated in accordance with time of change information relating to a time of change of system information to allow the user equipment receiving the telecommunications signal to compare current tag information to stored tag information and determine if stored system information is active system information.
